(19) United States
(12) Patent Application Publication
(10) Pub. No.: US 2010/0165789 A1
(43) Pub. Date: Jul. 1, 2010

(54) METHOD FOR DETERMINATION OF THE OIL FORMATION WATER-FLOODING AREA PATTERN AND SIZE IN THE WELLBORE ZONE

(75) Inventors: Oleg Nikolaevich Zhuravlev, Moscow region (RU); Dmitry Anatolievich Koroteev, Moscow (RU); Irina Anatolievna Gorban, Moscow region (RU)

Correspondence Address: SCHLUMBERGER-DOLL RESEARCH;ATTN: INTELLECTUAL PROPERTY LAW DEPARTMENT, P.O. BOX 425045, CAMBRIDGE, MA, 02142, US

(73) Assignee: SCHLUMBERGER TECHNOLOGY CORPORATION, Cambridge, MA (US)

(21) Appl. No.: 12/648,868

(22) Filed: Dec. 29, 2009

(30) Foreign Application Priority Data
Dec. 29, 2008 (RU) 2008152086

(51) Int. Cl. G01V 1/00

(52) U.S. Cl. 367/38

(57) ABSTRACT

The method for the determination of an oil formation's water-flooding area pattern and size in a borehole zone comprises grounded electrode installation at a certain distance away from the borehole sufficient enough to avoid electrical breakdowns. An electrical pulse generator is connected to a wellhead and to the electrode. A voltage pulse is applied between the wellhead and the electrode and electrical and/or acoustic response to electrical disturbances are measured. Pattern and size of the oil formation's water-flooding area is determined by an acquisition and processing system using a 4D seismic method. This method is technically simple to implement and may be applied under different field conditions.

### FIELD OF INVENTION

This invention relates to the oil well surveys, namely, to electrical and/or acoustic measurements, which are performed with the aim to determine oil formation's water-flooding area pattern and size in the wellbore zone.

### BACKGROUND OF THE INVENTION

In recent years, an idea of the real-time observation of the flood front has become more acute due to the depletion of oil fields and the application of residual oil displacement technologies, assuming water injection into injection wells. A great number of methods for the determination of the oil formation's water-flooding area pattern and size in the wellbore zone is available. e.g., ref. to U.S. Pat. No. 6,061,634, 2000, U.S. Pat. No. 6,182,013, 2001.

A method for the determination of the oil formation's water-flooding area pattern and size in the wellbore zone, which includes the connection of an electrical pulse generator to the wellhead and to the electrode, described in the Application [US 2003/0220750 A1, Publ. 27 Nov. 2003], is the closest analogue of the present invention (prototype). The authors suggest defining characteristic parameters of wellbore non-uniformities based on the results of combined acoustic and electrical measurements in the wellbore. The disadvantage of the above-mentioned method is that it virtually impossible to implement this method in case if non-uniformities exceed 1 m. Besides, the implementation of this method based on the selected prototype is a labor-intensive and energy-consuming process due to a complex design of the system, which is used for the implementation of this method.

### SUMMARY OF THE INVENTION

A task to be resolved by using present invention is to develop a simple, quick and effective method for determination of the oil formation's water-flooding area pattern and size in the wellbore zone.

Technical result to be reached through the implementation of the claimed technical solution is the development of a method which is technically simple for implementation and can be applied under different field conditions and allows precise measurements at a small size of the oil formation's flooding area in the wellbore zone.

The assigned technical result is reached by using the following features: connection of an electrical pulse generator to the wellhead and to an electrode, wherein the grounded electrode is installed at a certain distance away from the well, which should be sufficient enough to avoid electrical breakdowns; a voltage pulse is applied between the wellhead and the electrode; electrical and/or acoustic response to electrical disturbances is measured and a pattern and size of the oil formation's water-flooding area is defined, using a 4D seismic based data acquisition and processing system.

In addition, a rectangular voltage pulse is applied as a voltage pulse.

Besides, an electrical and/or acoustic response to electrical disturbances is measured by at least one electrical and/or acoustic transducer located either on the surface, or inside the well.

### BRIEF DESCRIPTION OF THE DRAWINGS

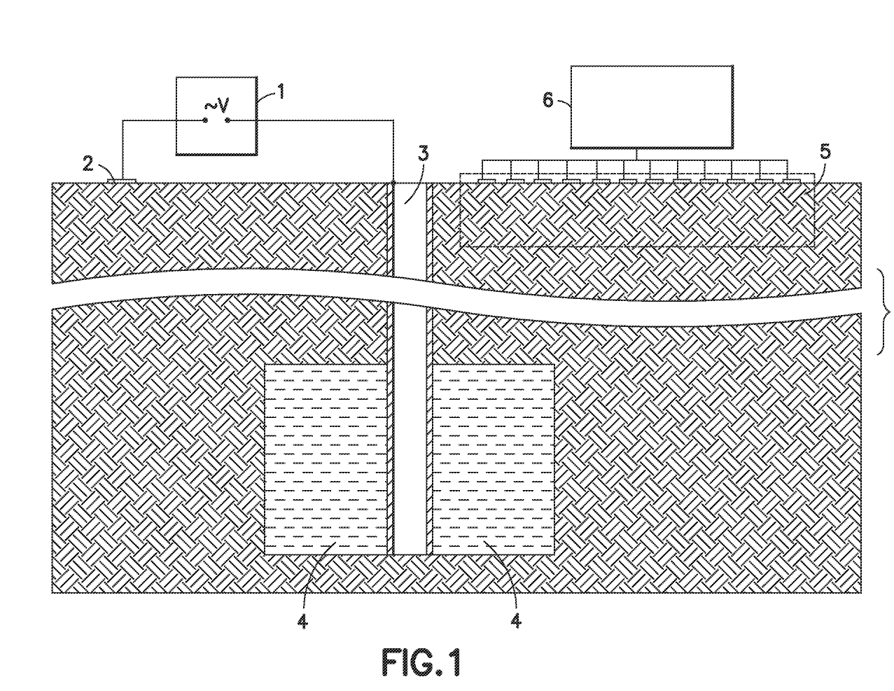

The invention is explained by the drawing, where FIG. 1 is a schematic diagram showing an oil well with the grounded electrode installment according to the invention.

### DETAILED DESCRIPTION OF THE PREFERRED EMBODIMENTS

One of the embodiments of the claimed method is schematically shown in FIG. 1. This embodiment assumes the connection of an electrical pulse generator (1) to a wellhead of an oil well (3) and to an electrode (2) grounded at a certain distance away from the well, which should be sufficient enough to avoid electrical breakdowns. The electric pulse generator (1) can be connected to the wellhead by a direct lowering of the cable end into the well, or it can be connected to the tubing string in case if a cased well is used. Thereafter, a rectangular voltage pulse is applied between the wellhead (3) and the electrode (2) and the electrical and/or acoustic response to electrical disturbances is measured by at least one electrical and/or acoustic transducer located in the well or/and on the surface. The nature of the response to the pulse disturbances depends on the shape of excitation signals. In case of rectangular signals, a front of the wellbore non-uniformity is a major contributor to the response signal (electrical and acoustic); this non-uniformity acts as an emitting surface (due to excess of charges of one or another sign on the above-mentioned surface when the above-mentioned voltage pulse is applied). So oil-formation's water-flooding area (4) boundaries are the major contributor to the detected signal. A 4D seismic logic is used to process measured data received from the distributed system of electric and/or acoustic transducers (5) by data acquisition and processing system (6) (e.g., ref. to http://www.4dseismic.com/). At this stage, a pattern and size of the oil formation's water-flooding area in the wellbore zone is defined.

Liquid, which is in contact with a well, has a higher conductivity, than surrounding rocks. In case of water-flooding, water with a sufficient salinity, e.g., may be used for the front observation in accordance with the claimed method.

1. A method for the determination of an oil formation's water-flooding area pattern and size in a wellbore zone, comprising the steps of:
installing a grounded electrode at a certain distance away from the well sufficient enough to avoid electrical breakdowns;
connecting an electrical pulse generator to a wellhead and to said electrode;
applying a voltage pulse between the wellhead and said electrode;
measuring electrical and/or acoustic response to electrical disturbances; and
determining the oil formation's water-flooding area pattern and size by an acquisition and processing system using a 4D seismic method.

2. A method of claim 1, wherein a rectangular voltage pulse is applied as a voltage pulse.

3. A method of claim 1, wherein electrical and/or acoustic response to electrical disturbances is measured by at least one electrical and/or acoustic transducer located either on the surface, or in the wellbore.
